(19) United States
(12) Patent Application Publication
(10) Pub. No.: US 2005/0237884 A1
(43) Pub. Date: Oct. 27, 2005

(54) Information recording apparatus and method, and computer program product

(76) Inventor: Naoharu Yanagawa, Saitama (JP)

Correspondence Address: YOUNG & THOMPSON, 745 SOUTH 23RD STREET, 2ND FLOOR, ARLINGTON, VA, 22202, US

(21) Appl. No.: 11/081,520

(22) Filed: Mar. 17, 2005

(30) Foreign Application Priority Data
Mar. 17, 2004 (JP) 2004-76026

(51) Int. Cl. G11B 7/00

(52) U.S. Cl. 369/47.53

(57) ABSTRACT

An recording apparatus is provided with: an recording device for recording information onto an recording medium by irradiating laser light; and a measuring device for measuring reproduction quality of the information recorded in a area adjacent to the information to be additionally recorded. The information recording device additionally records the record information into a link area, which is next to the recording area adjacent to the record information to be additionally recorded, with a record parameter on which the reproduction quality measured by the first measuring device is obtained, if the record information is additionally recorded into the link area.

### BACKGROUND OF THE INVENTION

1. Field of the Invention

The present invention relates to an information recording apparatus, such as a DVD recorder, an information recording method, and a computer program product which makes a computer function as the information recording apparatus.

2. Description of the Related Art

In an information recording/reproducing apparatus for recording information onto an information recording medium, such as an optical disc, the optimum power of a recording power is set by Optimum Power Control (OPC) processing, in accordance with the type of the optical disc, the type and the recording speed of the information recording/reproducing apparatus, and the like. Namely, the calibration of the recording power is performed. This makes it possible to realize an appropriate recording operation. For example, if a command of writing is inputted after the optical disc is inserted or loaded, light intensity is changed step-by-step sequentially, and the data for trial writing (i.e. the data for the OPC operation) is recorded into an OPC area, so that so-called trial writing (i.e. the trial writing of the data for the OPC operation) is performed. Afterward, the data for trial writing recorded in this manner is reproduced. The reproduction result is judged on the basis of a predetermined evaluation reference, and the optimum power is set. In an information recording apparatus disclosed in Japanese Patent Application Laying Open No. 2001-297439, the recording power obtained by the OPC operation is adjusted on the basis of reproduction quality obtained by reproducing the actually recorded data. Then, the data recorded in this manner is reproduced as various video, audio, and the like, while it is searched for by an auto slicer (referring to Japanese Patent Application Laying Open No. Hei 10-55503).

Moreover, in some information recording apparatuses, a recording operation in which the information can be additionally recorded onto the optical disc sequentially (e.g. incremental write) is performed. In this recording operation, the data is additionally recorded by treating a recording area corresponding to an error correction unit, such as an Error Correction Code (ECC) block, as a link area (a connection area), for example.

### SUMMARY OF THE INVENTION

However, in the above-described OPC operation, the calibration of the recording power is performed in a predetermined Power Calibration Area (PCA) on the optical disc. The PCA is generally placed on the most inner circumferential side or most outer circumferential side on the optical disc, for example. On the other hand, in the optical disc or the like, it is general that recording characteristics in its recording surface is not necessarily uniform, due to the production condition and the production method of the optical disc. Moreover, the information recording apparatuses individually have their own characteristics. And the desired reproduction quality of the data recorded by one apparatus may not be obtained as expected if the data is reproduced by an apparatus other than the one apparatus that records the data. Therefore, if the data is additionally recorded, it is technically difficult or almost impossible to maintain the continuity of the reproduction quality of the data, between a recording area before (or immediately before) the additional recording and a recording area in which the data is newly additionally recorded. Particularly, asymmetry, which is a specific example of the reproduction quality, does not change continuously (i.e. the asymmetry changes drastically), so that the auto slicer of the information reproducing apparatus cannot properly search and follow recording pits or recording marks that indicate the data which is recorded. Thus, it is technically difficult or almost impossible to properly reproduce the data.

Moreover, even if the recording power is adjusted on the basis of the reproduction quality of the data, as in Japanese Patent Application Laying Open No. 2001-297439, the value of the power obtained at one recording area is not necessarily optimum at the other recording area, in view of the scattering of the recording characteristics and the tendency of its change. Moreover, in Japanese Patent Application Laying Open No. 2001-297439, it is necessary to actually record the data into a recording area which is the object, in order to adjust the recording power. Thus, it is technically difficult or almost impossible to adjust the recording power in a recording area in which the data is not recorded.

It is therefore an object of the present invention to provide an information recording apparatus and an information recording method, which can perform the recording of information with an appropriate recording power onto an information recording medium, such as an optical disc, and particularly, which can perform the additional recording of the information with the appropriate recording power, as well as a computer program which makes a computer as such an information recording apparatus, for example

The above object of the present invention can be achieved by a first information recording apparatus provided with: an information recording device for recording record information onto an information recording medium by irradiating the information recording medium with laser light having a variable recording power; and a first measuring device for measuring, if the record information is additionally recorded, reproduction quality of the record information recorded in a recording area adjacent to the record information to be additionally recorded; wherein the information recording device additionally records the record information into a link area, which is next to the recording area adjacent to the record information to be additionally recorded, with a record parameter on which the reproduction quality measured by the first measuring device is obtained, if the record information is additionally recorded into the link area.

According to the first information recording apparatus, it is possible to record various types of the record information by the operation of the information recording device.

Particularly, in the first information recording apparatus, if the record information is additionally recorded (e.g. incremental write is performed), it is possible to perform the appropriate recording operation. Specifically, if the record information is additionally recorded, the reproduction quality of the record information recorded in the recording area adjacently to the recording area to be additionally recorded the record information by the operation of the first measuring device. Here, the “record information recorded in an adjacent recording area” indicates the record information recorded in the adjacent recording area as it is written, and also includes the record information recorded in the recording area which equates to the adjacent recording area (i.e. an identifiably adjacent recording area). And the record information is additionally recorded into the link area next to the adjacent recording area (i.e. the recording area on which the record information is to be recorded) with the record parameter (i.e. the record condition) on which the reproduction quality measured by the first measuring device is obtained. In other words, the reproduction quality of the record information recorded into the link area is same or substantially same to that recorded into the adjacent recording area.

By this, even if the record information is additionally recorded, it is possible to smoothly change the reproduction quality of the record information, without an abrupt change. Namely, it is possible to maintain the continuity of the reproduction quality. Therefore, even in reproducing the record information, there does not arise the situation that the reproduction quality is abruptly changed at a position where the record information is additionally recorded, for example. Namely, the record information can be properly recorded (i.e. without the abrupt change of the quality) even at the position where the record information is additionally recorded, so that it is possible to properly reproduce the record information.

As a result, according to the first information recording apparatus of the present invention, it is possible to realize the appropriate recording operation without abruptly changing the reproduction quality of the record information, even in the case of the additional recording of the record information.

In one aspect of the first information recording apparatus of the present invention, the record parameter is defined by one of or at least two of the recording power, a recording strategy, a tilt condition in recording, defocus condition and de-track condition, the record parameter is optimized so that the reproduction quality measured by the first measuring device is obtained on the link area, if the record information is additionally recorded into the link area.

According to this aspect, at least one of the recording power, a recording strategy, a tilt condition in recording, defocus condition and de-track condition is/are optimized so that the reproduction quality measured by the first measuring device is obtained.

In another aspect of the first information recording apparatus of the present invention, the first information recording apparatus is further provided with a first detecting device for detecting a link power, which is the recording power from which the reproduction quality measured by the first measuring device is obtained, on the basis of correlation information for indicating a correlation between the recording power and the reproduction quality associated with the record information; wherein the information recording device additionally records the record information into the link area with the link power detected by the first detecting device.

According to this aspect, the link power corresponding to the recording power which realizes the reproduction quality measured by the first measuring device is detected. The detection of the link power is performed on the basis of the correlation information for indicating the correlation relationship between the recording power and the reproduction quality of the record information recorded with this recording power.

Thus, it is possible to detect the recording power according to 15 or appropriate for an actual recording state, relatively easily. Namely, the recording power can be adjusted on the basis of the tendency of the change in the recording power indicated by the correlation information. In this regard, it can be said that the present invention has effects, superior to those of the invention described in Japanese Patent Application Laying Open No. 2001-297439, and the like. The operation of adjusting the recording power on the basis of the correlation information will be explained in detail in “DETAILED DESCRIPTION OF THE PREFERRED EMBODIMENT” described later.

In another aspect of the first information recording apparatus of the present invention, the information recording apparatus is further provided with a second detecting device for detecting a link strategy, which is a recording strategy from which the reproduction quality measured by the first measuring device is obtained, on the basis of correlation information for indicating a correlation between the recording strategy and the reproduction quality associated with the record information; wherein the information recording device additionally records the record information into the link area with the link strategy detected by the second detecting device.

According to this aspect, the recording strategy can be changed in the additional recording. Especially, the link strategy corresponding to the recording power which realizes the reproduction quality measured by the first measuring device is detected. The detection of the link strategy is performed on the basis of the correlation information for indicating the correlation relationship between the recording strategy and the reproduction quality of the record information recorded with this recording strategy.

By this, even if the record information is additionally recorded, it is possible to maintain the continuity of the reproduction quality.

Therefore, it is possible to properly reproduce the record information.

Furthermore, it is possible to detect the recording strategy according to or appropriate for an actual recording state, relatively easily. Namely, the recording strategy can be adjusted on the basis of the tendency of the change in the recording strategy indicated by the correlation information.

In another aspect of the first information recording apparatus of the present invention, the information recording apparatus is further provided with a rotation controlling device for controlling a liner velocity of the information recording medium such that a first velocity, which is the liner velocity in the additional recording of the record information, is more suitable to the recording of the record information compared to a second velocity, which is the liner velocity in normal recording other than the additional recording of the record information.

According to this aspect, by the operation of the rotation controlling device, the liner velocity (i.e. a recording speed or the like) is controlled to be the first velocity more suitable to the recording operation compared to the second velocity in the normal recording operation of the record information. Namely, the record information is additionally recorded by reducing the liner velocity of the information recording medium (or by reducing the recording speed). Therefore, it is possible to efficiently solve the problem of the discontinuity of the reproduction quality, which becomes a great issue in the high-velocity recording (high-speed recording).

In an aspect of the first information recording apparatus provided with the first detecting device as described above, the information recording apparatus is further provided with a first adjusting device for adjusting the recording power stepwise by a predetermined adjustment amount, or continuously in a predetermined ratio, such that the recording power changes from the link power to a reference power, which is the recording power from which desired first target quality is obtained as the reproduction quality, if the record information is additionally recorded.

According to this aspect, by the operation of the first adjusting device, the recording power is adjusted to smoothly change from the link power to the reference power, if the record information is actually additionally recorded. The reference power corresponds to the recording power from which the desired first target quality is obtained as the reproduction quality. The smooth change of the recording power (i.e. soft landing described later) can be realized by changing it stepwise by a predetermined adjustment amount, or continuously in a predetermined ratio.

By this, even if the record information is additionally recorded, it is possible to maintain the continuity of the reproduction quality. Therefore, that it is possible to properly reproduce the record information.

Incidentally, the extent of the predetermined adjustment amount or predetermined adjustment ratio may be variable. By this, it is possible to set the degree of the change in the recording power, as occasion demands. For example, if the predetermined adjustment amount or predetermined adjustment ratio is set to be relatively small, the change in the recording power can be made relatively mild. On the other hand, if the predetermined adjustment amount or predetermined adjustment ratio is set to be relatively large, the change in the recording power can be made relatively abrupt.

In an aspect of the first information recording apparatus provided with the first adjusting device as described above, the first adjusting device adjusts the recording power to the reference power directly, if a difference between the link power and the reference power is less than or equal to a predetermined amount.

According to this aspect, if the difference between the link power and the reference power is less than or equal to the predetermined amount, even if the recording power is abruptly adjusted to the reference power without changing it stepwise or continuously, it is possible to properly reproduce the record information because the reproduction quality does not vary widely. On the other hand, if the difference between the link power and the reference power is more than or equal to the predetermined amount, the recording power is adjusted to change from the link power to the reference power, stepwise or continuously. Therefore, it is unnecessary to perform the stepwise or continuous adjustment of the recording power needlessly, so that it is possible to improve the processing performance of the recording operation.

In an aspect of the first information recording apparatus provided with the second detecting device as described above, the information recording apparatus is further provided with a second adjusting device for adjusting the recording strategy stepwise by a predetermined adjustment amount, or continuously in a predetermined ratio, such that the recording strategy changes from the link strategy to a reference strategy, which is the recording strategy from which desired first target quality is obtained as the reproduction quality, if the record information is additionally recorded.

According to this aspect, by the operation of the second adjusting device, the recording strategy is adjusted to smoothly change from the link strategy to the reference strategy, if the record information is actually additionally recorded. The reference strategy corresponds to the recording strategy from which the desired first target quality is obtained as the reproduction quality. The smooth change of the recording strategy (i.e. soft landing described later) can be realized by changing it stepwise by a predetermined adjustment amount, or continuously in a predetermined ratio.

By this, even if the record information is additionally recorded, it is possible to maintain the continuity of the reproduction quality. Therefore, that it is possible to properly reproduce the record information.

In an aspect of the first information recording apparatus provided with the second adjusting device as described above, the second adjusting device adjusts the recording strategy to the reference strategy directly, if a difference between the link strategy and the reference strategy is less than or equal to a predetermined amount.

According to this aspect, if the difference between the link strategy and the reference strategy is less than or equal to the predetermined amount, even if the recording strategy is abruptly adjusted to the reference strategy without changing it stepwise or continuously, it is possible to properly reproduce the record information because the reproduction quality does not vary widely. On the other hand, if the difference between the link strategy and the reference strategy is more than or equal to the predetermined amount, the recording strategy is adjusted to change from the link strategy to the reference strategy, stepwise or continuously. Therefore, it is unnecessary to perform the stepwise or continuous adjustment of the recording strategy needlessly, so that it is possible to improve the processing performance of the recording operation.

In an aspect of the first information recording apparatus provided with the rotation controlling device as described above, pre-information including address information is recorded on the information recording medium, the information recording apparatus is further provided with a second measuring device for measuring the reproduction quality of the pre-information, and the first velocity is the liner velocity at which desired second target quality is obtained as the reproduction quality of the pre-information measured by the second measuring device.

According to this aspect, it is possible to maintain the reproduction quality of the pre-information in the desired condition (i.e. the desired second target quality), so that it is possible to properly read the address information and the like. As a result, it is possible to properly record the record information.

The above object of the present invention can be also achieved by a second information recording apparatus provided with: a rotating device for rotating an information recording medium; a rotation controlling device for controlling the rotating device to thereby change a liner velocity of the information recording medium;

an information recording device for recording record information onto the information recording medium by irradiating the information recording medium with laser light; a power controlling device for controlling a recording power of the laser light; and a first measuring device for measuring reproduction quality of the record information recorded on the information recording medium, wherein the liner velocity is changed by the rotation controlling device, and the recording power is controlled by the power controlling device so that the record information is additionally recorded with the recording power according to the reproduction quality measured by the first measuring device.

According to the second information recording apparatus, as in the first information recording apparatus, it is possible to preferably record the record information by the operation of the information recording device. Moreover, it is possible to change (or control) the liner velocity of the information recording medium by the operation of the rotation controlling device.

Particularly, in the second information recording apparatus, the liner velocity can be changed by the operation of the rotation controlling device, and the record information can be additionally recorded by changing the recording power (e.g. from the link power to the reference power) according to the reproduction quality of the record information measured by the operation of the first measuring device. For example, as described above, while the recording power is changed so as to reduce the liner velocity and maintain the continuity of the reproduction quality (i.e. so as to solve the problem of the discontinuity of the reproduction quality), the record information can be additionally recorded.

As a result, according to the second information recording apparatus of the present invention, it is possible to receive the same benefit as that of the above-described first information recording apparatus of the present invention.

In one aspect of the second information recording apparatus of the present invention, the power controlling device controls the recording power to stepwise or continuously change to a reference power, which is the recording power from which desired first target quality is obtained as the reproduction quality, while the record information is additionally recorded.

According to this aspect, in the case that the additional recording is performed with the recording power according to the measured reproduction quality, it is possible to perform the recording operation with the reference power, which is the preferable recording power, after the continuity of the reproduction quality is maintained. Therefore, it is possible to maintain the reproduction quality of the record information, in a preferable condition, regardless of whether or not it is in the additional recording.

In an aspect of the second information recording apparatus in which the recording power is changed to the reference power as described above, the first measuring device may measure the reproduction quality of the record information recorded on the information recording medium, and the power controlling device may control the recording power to stepwise or continuously change from a link power, which is the recording power from which the reproduction quality measured by the first measuring device is obtained, to the reference power.

By such a construction, the recording power is controlled to change from the link power to the reference power, so that it is possible to maintain the continuity of the reproduction quality more preferably. Namely, it is possible to receive the same benefit as that of the above-described first information recording apparatus.

In another aspect of the second information recording apparatus of the present invention, the second information recording apparatus is further provided with the strategy controlling device for controlling a recording strategy.

According to this aspect, as in the first information recording apparatus, the record information can be additionally recorded by changing the recording strategy (e.g. from the link strategy to the reference strategy) according to the reproduction quality of the record information measured by the operation of the first measuring device. For example, as described above, while the recording strategy is changed so as to reduce the liner velocity and maintain the continuity of the reproduction quality (i.e. so as to solve the problem of the discontinuity of the reproduction quality), the record information can be additionally recorded.

As a result, it is possible to receive the same benefit as that of the above-described first information recording apparatus of the present invention.

In an aspect of the second information recording apparatus provided with the strategy controlling device as described above, the strategy controlling device controls the recording strategy to stepwise or continuously change to a reference strategy, which is the recording strategy from which desired first target quality is obtained as the reproduction quality, while the record information is additionally recorded.

According to this aspect, in the case that the additional recording is performed with the recording strategy according to the measured reproduction quality, it is possible to perform the recording operation with the reference strategy, which is the preferable recording strategy, after the continuity of the reproduction quality is maintained. Therefore, it is possible to maintain the reproduction quality of the record information, in a preferable condition, regardless of whether or not it is in the additional recording.

In an aspect of the second information recording apparatus in which the recording strategy is changed to the reference strategy as described above, the first measuring device may measure the reproduction quality of the record information recorded on the information recording medium, and the strategy controlling device may control the recording strategy to stepwise or continuously change from a link strategy, which is the recording strategy from which the reproduction quality measured by the first measuring device is obtained, to the reference strategy.

By such a construction, the recording strategy is controlled to change from the link strategy to the reference strategy, so that it is possible to maintain the continuity of the reproduction quality more preferably. Namely, it is possible to receive the same benefit as that of the above-described first information recording apparatus.

In another aspect of the second information recording apparatus of the present invention, pro-information including address information is recorded on the information recording medium, the information recording apparatus is further provided with a second measuring device for measuring the reproduction quality of the pre-information, and the rotation controlling device changes the liner velocity so that desired second target quality is obtained as the reproduction quality of the pre-information.

According to this aspect, it is possible to properly obtain the address information by controlling or changing the liner velocity so as to set the reproduction quality of the pre-information to be in a preferable condition (i.e. the second target reproduction quality) Therefore, it is possible to ensure the preferable recording operation.

In an aspect of the first or second information recording apparatus in which the reproduction quality of the pre-information is measured as described above, the reproduction quality of the pre-information may be at least one of an Aperture Rate (AR) characteristic and a LPP characteristic after recording.

By such a construction, it is possible to control or change the liner velocity such that one of or both of the AR characteristic and a LPP characteristic after recording (i.e. BERLPPa described later) realizes an excellent value.

In an aspect of the first or second information recording apparatus in which the reproduction quality of the pre-information is measured as described above, the reproduction quality of the pre-information is at least one of a C/N characteristic of a wobble and error rate characteristic of the wobble. By such a construction, it is possible to control or change the liner velocity such that one of or both of the C/N characteristic and a wobble error rate realizes an excellent value.

In another aspect of the second information recording apparatus of the present invention, the power controlling device controls the recording power to additionally record the record information with the recording power according to the reproduction quality measured by the first measuring device, on the basis of correlation information for indicating a correlation relationship between the recording power and the reproduction quality.

According to this aspect, as in the first information recording apparatus, it is possible to control the recording power more preferably, on the basis of the correlation information.

In an aspect of the second information recording apparatus provided with the strategy controlling device as described above, the strategy controlling device controls the recording strategy to additionally record the record information with the recording strategy according to the reproduction quality measured by the first measuring device, on the basis of correlation information for indicating a correlation relationship between the recording strategy and the reproduction quality.

According to this aspect, as in the first information recording apparatus, it is possible to control the recording strategy more preferably, on the basis of the correlation information.

In an aspect of the first or second information recording apparatus using the correlation information as described above, the information recording apparatus is further provided with: a trial recording device for recording trial information into a predetermined recording area of the information recording medium while changing at least one of the recording power and the recording strategy; and a preparing device for preparing the correlation information by reproducing the trial information.

According to this aspect, the link power or the link strategy can be properly detected by using the correlation information prepared by the operation of the preparing device, and at the same time, the reference power or the reference strategy can be detected. Thus, it is possible to properly perform the adjustment operation of the recording power or the recording strategy.

In an aspect of the first or second information recording apparatus provided with the preparing device as described above, the information recording device may record the correlation information onto the information recording medium.

By such a construction, it is possible to adjust the recording power or the recording strategy by an appropriate adjustment amount or in an appropriate adjustment ratio, not only on an information recording apparatus in which the correlation information is actually obtained, but also on another information recording apparatus (e.g. an information recording apparatus on which the record information is never recorded onto the information recording medium), by referring to the correlation information recorded on the information recording medium, which is greatly advantageous.

In an aspect of the first or second information recording apparatus provided with the preparing device as described above, the information recording apparatus may be further provided with a storing device for storing the correlation information therein.

By such a construction, it is possible to continue to use the once prepared correlation information after the preparation. Therefore, it is possible to save the labor required for the another preparation of the correlation information, in detecting the link power or the like again.

Particularly, because the correlation information is stored into the storing device provided for the information recording apparatus itself, it is possible to detect the link power, the link strategy or the like, by using the correlation information, even in recording the record information onto an information recording medium different from an information recording medium on which the correlation information is prepared. Thus, it becomes particularly efficient when the record information is recorded onto an information recording medium of the same type, of the same quality, and made by the same manufacturer.

At this time, the correlation information may be stored, for each identification number of the information recording medium (e.g. a manufacturer number and the like).

In another aspect of the first or second information recording apparatus of the present invention, the reproduction quality of the record information includes at least one of an asymmetry value, a jitter value, and a reproduction error rate.

According to this aspect, the reference power, the link power, the link strategy or the like is obtained by combining those reproduction qualities, as occasion demands, by which it is possible to properly adjust the recording power so as to realize the more appropriate recording operation.

(Information Recording Method)

The above object of the present invention can be also achieved by a first information recording method on an information recording apparatus provided with an information recording device for recording record information onto an information recording medium by irradiating the information recording medium with laser light having a variable recording power, the information recording method provided with: a first measuring process of measuring, if the record information is additionally recorded, reproduction quality of the record information recorded in a recording area adjacent to the record information to be additionally recorded; and a recording process of recording the record information, wherein the record information is additionally recorded into a link area, which is next to the recording area adjacent to the record information to be additionally recorded, with a record parameter on which the reproduction quality measured in the first measuring process is obtained, if the record information is additionally recorded into the link area. According to the first information recording method of the present invention, it is possible to receive the same benefit as that of the first information recording apparatus of the present invention.

Incidentally, in response to various aspects in the above-described first information recording apparatus of the present invention, the first information recording method of the present invention can also adopt various aspects.

The above object of the present invention can be also achieved by a second information recording method on an information recording apparatus provided with: a rotating device for rotating an information recording medium; and an information recording device for recording record information onto the information recording medium by irradiating the information recording medium with laser light, the information recording method provided with: a rotation controlling process of controlling the rotating device to thereby change a liner velocity of the information recording medium; a power controlling process of controlling a recording power of the laser light; and a first measuring process of measuring reproduction quality of the record information recorded on the information recording medium, wherein the liner velocity is changed in the rotation controlling process, and the recording power is controlled in the power controlling process so that the record information additionally recorded with the recording power according to the reproduction quality measured by the first measuring device.

According to the second information recording method of the present invention, it is possible to receive the same benefit as that of the second information recording apparatus of the present invention.

Incidentally, in response to various aspects in the above-described second information recording apparatus of the present invention, the second information recording method of the present invention can also adopt various aspects.

(Computer Program Product)

The above object of the present invention can be also achieved by a computer program product in a computer-readable medium for tangibly embodying a program of instructions executable by a computer to make the computer function as the above-described first or second information recording apparatus (including its various aspects).

According to the computer program product of the present invention, the above-described first or second information recording apparatus of the present invention can be embodied relatively readily, by loading the computer program product from a recording medium for storing the computer program product, such as a ROM (Read Only Memory), a CD-ROM (Compact Disc—Read Only Memory), a DVD-ROM (DVD Read Only Memory), a hard disk or the like, into the computer, or by downloading the computer program product, which may be a carrier wave, into the computer via a communication device. More specifically, the first or second computer program product may include computer readable codes to cause the computer (or may comprise computer readable instructions for causing the computer) to function as the above-described first or second information recording apparatus.

Incidentally, in response to various aspects in the above-described first or second information recording apparatus of the present invention, the computer program product of the present invention can also adopt various aspects.

The nature, utility, and further features of this invention will be more clearly apparent from the following detailed description with reference to preferred embodiment of the invention when read in conjunction with the accompanying drawings briefly described below.

As described above, according to the first information recording apparatus of the present invention, it is provided with: the information recording device; and the first measuring device. According to the first information recording method of the present invention, it is provided with: the first measuring process; and the recording process. According to the second information recording apparatus of the present invention, it is provided with: the rotating device; the rotation controlling device; the information recording device; the power controlling device; and the first measuring device. According to the second information recording method of the present invention, it is provided with: the rotation controlling process; the power controlling process; and the first measuring process. Therefore, even if the record information is additionally recorded, it is possible to record the record information with the appropriate recording power. Consequently, even at the time of reproduction, it is possible to reproduce the information properly.

### BRIEF DESCRIPTION OF THE DRAWINGS

FIG. 1 is a diagram showing the basic structure of an optical disc as being one embodiment of an information recording medium used an information recording apparatus in an embodiment of the present invention, the upper part being a schematic plan view of the optical disc having a plurality of areas, the corresponding bottom part being a schematic diagram of the structures of the areas in the radial direction;

FIG. 2 is a block diagram conceptually showing the basic structure of the information recording apparatus in the embodiment of the present invention;

FIG. 3 is a flowchart showing the flow of a whole data recording operation on the information recording apparatus in the embodiment;

FIG. 4 is a flowchart showing the flow of an OPC operation on the information recording apparatus in the embodiment;

FIG. 5 is a table showing specific numerical values of a recording laser power and asymmetry, obtained on the information recording apparatus in the embodiment;

FIG. 6 is a graph conceptually showing correlation information prepared on the information recording apparatus in the embodiment;

FIG. 7 is a flowchart showing the flow of an additional recording operation, on the information recording apparatus in the embodiment;

FIG. 8 is a graph conceptually showing a state on the correlation information in the additional recording operation, on the information recording apparatus in the embodiment;

FIG. 9A is an explanatory diagram conceptually showing the state of the asymmetry in a additional recording operation of the information recording apparatus in the embodiment, and FIG. 9B is an explanatory diagram conceptually showing the state of the asymmetry in a additional recording operation of the compared information recording apparatus.

FIG. 10A is a perspective view conceptually explaining the shapes of recording marks (recording pits) formed in low-velocity recording by the information recording apparatus in the embodiment, and FIG. 10B is a perspective view conceptually explaining the shapes of recording marks formed in high-velocity recording by the information recording apparatus in the embodiment;

FIG. 11 is a graph showing a correlation relationship between the liner velocity (recording speed) of the optical disc and the recording laser power, prepared in a first modified operation of the information recording apparatus in the embodiment;

FIG. 12 is a flowchart showing one operational flow in the first modified operation of the information recording apparatus in the embodiment;

FIG. 13 is a flowchart showing another operational flow in the first modified operation of the information recording apparatus in the embodiment;

FIG. 14 is a graph showing a correlation relationship between the recording laser power and the asymmetry, if the liner velocity of the optical disc is changed, in the first modified operation of the information recording apparatus in the embodiment; and

FIG. 15 is a flowchart showing an operational flow in a second modified operation of the information recording apparatus in the embodiment.

### DETAILED DESCRIPTION OF THE PREFERRED EMBODIMENT

An embodiment of the present invention will be hereinafter explained with reference to the drawings.

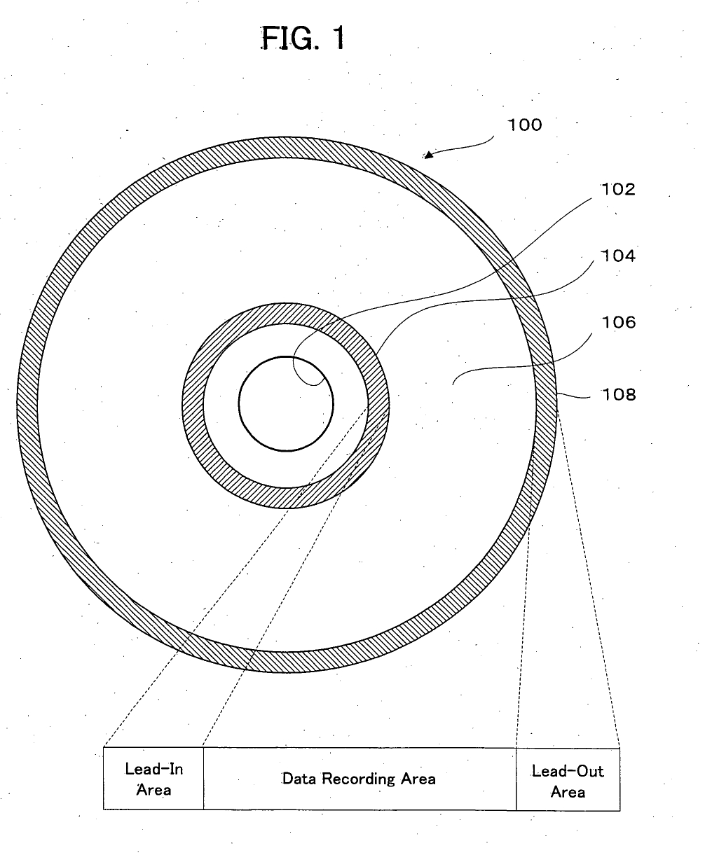

At first, an information recording medium used in an information recording apparatus in the embodiment of the present invention will be explained, with reference to FIG. 1. In the embodiment, the explanation is given by using an optical disc of a recording type as the information recording medium. FIG. 1 shows the structure of the optical disc having a plurality of areas in a schematic plan view on the upper part, and shows the structures of the areas in the radial direction in a schematic diagram on the corresponding bottom part.

As shown in FIG. 1, an optical disc 100 is recordable in various recoding methods, such as a magneto optical method and a phase transition method, in which it is possible to record (write) information a plurality of times or only once. The optical disc 100 has a recording surface on the disc main body, which is about 12 cm in diameter, as is the DVD. On the recording surface, the optical disc 100 is provided with: a lead-in area 104; a data recording area 106; and a lead-out area 108, with a center hole 102 as the center, in the direction from the inner circumference to the outer circumference. In each area, groove tracks and land tracks are alternately placed, spirally or coaxially, with the center hole 102 as the center, for example. These groove tracks may be wobbled, and pre-pits may be formed on either or both of the groove tracks and the land tracks. Incidentally, the present invention is not specially limited to the optical disc having these three areas. For example, even if there is no lead-in area 104 nor lead-out area 108, a file structure described later can be constructed. Moreover, the lead-in area 104 and the lead-out area 108 may be further segmentalized.

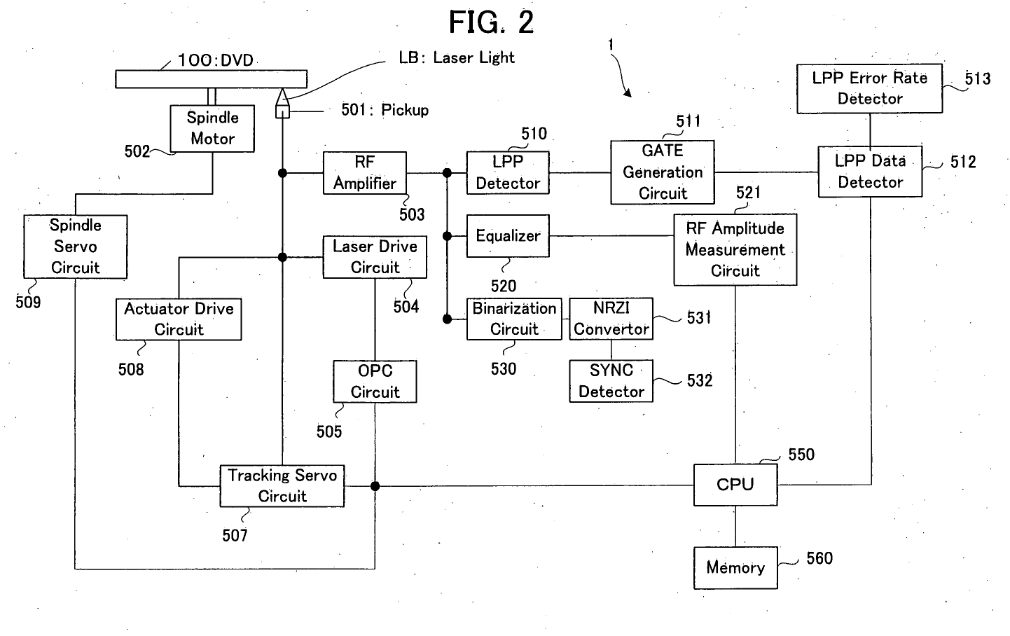

Next, with reference to FIG. 2 to FIG. 15, the information recording apparatus in the embodiment of the present invention will be explained.

(Basic Structure)

At first, the basic structure of the information recording apparatus in the embodiment will be explained with reference to FIG. 2. FIG. 2 conceptually shows the basic structure of the information recording apparatus in the embodiment.

As shown in FIG. 2, an information recording apparatus 1 in the embodiment includes: an optical pickup 501; a spindle motor 502; a Radio Frequency (RF) amplifier 503; a laser drive circuit 504; an Optimum Power Calibration (OPC) circuit 505; a tracking servo circuit 507; an actuator drive circuit 608; a spindle servo circuit 509; a Land Pre Pit (LPP) detector 510; a GATE generation circuit 511; a LPP data detector 512; a LPP error rate detector 513; an equalizer 520; a RF amplitude measurement circuit 521; a binarization circuit 530; a Non Return to Zero Inversion (NRZI) converter 531; a SYNC detector 532; a Central Processing Unit (CPU) 550; and a memory 560.

The optical pickup 501 is one specific example of the “information recording device” of the present invention. The optical pickup 501 performs the recording/reproduction with respect to the optical disc 100, and is provided with: a semiconductor laser device; various lenses; an actuator; and the like. More specifically, at the time of reproduction, the optical pickup 501 irradiates the optical disc 100 with a light beam, such as a laser light LB, as reading light with a first power. At the time of recording, the optical pickup 501 irradiates the optical disc 100 with the light beam, with it modulated, as writing light with a second power. Such a power adjustment of the laser light LB is performed under the control of the laser drive circuit 504, which is one specific example of the “first and second adjusting device” described later. More specifically, the semiconductor laser device is driven by a driving pulse which is defined by a predetermined pulse strategy. By this, the optical disc 100 is irradiated with the laser light LB having a predetermined laser power. Moreover, the optical pickup 501 is displaced in the radial direction of the optical disc 100, by the actuator drive circuit 508 driven by the tracking servo circuit 507, a not-illustrated slider, and the like.

The spindle motor 502 is one specific example of the “rotating device” of the present invention. The spindle motor 502 rotates the optical disc 100 at a predetermined velocity while receiving spindle servo from the spindle servo circuit 509.

The RF amplifier 503 amplifies a signal (i.e. a reading signal) outputted from a not-illustrated Photo Detector (PD) that receives the reflected light of the laser light LB emitted from the optical pickup 501, and outputs the amplified signal. More specifically, the RF amplifier 503 outputs a RF signal (or a LPP signal, a wobble signal, and the like) as being a reading signal, to the LPP detector 510, the equalizer 520, and the binarization circuit 530.

The laser drive circuit 504 is one specific example of the “first and second adjusting device” or the “power controlling device” of the present invention. At the time of OPC processing described later, the laser drive circuit 504 drives the semiconductor laser provided in the optical pickup 501 so as to determine an optimum recording laser power by the recording and reproduction processing of an OPC pattern described later. Then, at the time of data recording, the laser drive circuit 504 drives the semiconductor laser with the optimum recording laser power determined by the OPC processing. At the time of data recording, the optimum recording laser power is modulated depending on the record data.

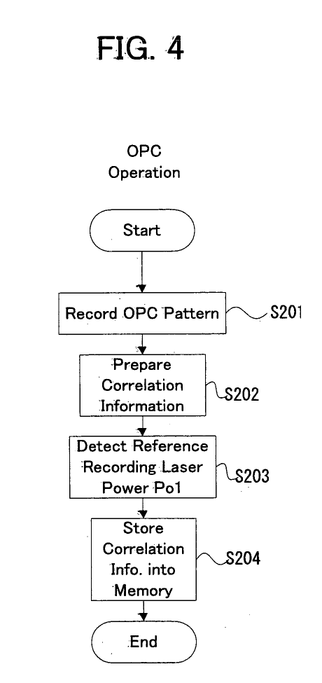

The OPC circuit 505 is one specific example of the “trial writing device” of the present invention. The OPC circuit 605 outputs a signal for indicating the OPC pattern, to the laser drive circuit 504, at the time of recording the OPC pattern in the OPC processing before the recording operation. Incidentally, the OPC processing will be described in detail later (refer to FIG. 4 and the like).

The tracking servo circuit 507 can detect various servo signals, such as a tracking error signal, from the reading signal obtained from the optical pickup 501. The various servo signals can be outputted to the actuator drive circuit 508 or the spindle motor 502.

The actuator drive circuit 508 can control the displacement of the optical pickup 501 in the radial direction or the rotational direction of the optical disc 100, on the basis of the various servo signals outputted from the tracking servo circuit 507. The laser light LB is irradiated to the desired recording position of the optical disc 100 by the optical pickup 501 whose displacement is controlled by the actuator drive circuit 507. By this, various data can be recorded.

The spindle servo circuit 509 is one specific example of the “rotation controlling device” of the present invention. The spindle servo circuit 509 can control the driving of the spindle motor 502, on the basis of a spindle servo signal, under the control of the CPU 550. Specifically, the spindle servo circuit 509 controls the number of rotations of the spindle motor 502, to thereby control the liner velocity of the optical disc 100 (or the recording speed of the data).

The LPP detector 510 can detect a push-pull signal for indicating the LPP signal, on the basis of the output signal corresponding to the amount of light received from the RF amplifier 503. At this time, in order to detect the push-pull signal, preferably, the light receiving element (or photo detection element of the photo detector) of the optical pickup 501 can receive the reflected light of the laser light LB in a plurality of divisional areas, such as 2 divisional areas or 4 divisional areas.

Incidentally, the LPP is one specific example of the “pre-information” of the present invention. The LPP is a pit formed in advance on the recording tracks (particularly, the land tracks) of a DVD-R/RW or the like, which is one specific example of the optical disc 100. For example, the LPP is used for the generation of address information or a recording clock signal at the time of data recording.

The GATE generation circuit 511 can generate a gate signal for detecting LPP data. Specifically, by generating the gate signal with respect to a wobble in which the LPP is formed, the GATE generation circuit 511 can detect the LPP data and efficiently remove a noise included in the LPP data. It is obvious that the LPP data can be detected from the gate signal which is generated by detecting the wobble signal.

The LPP data detector 512 can detect the LPP data, on the basis of the gate signal generated by the GATE generation circuit 511, from the LPP signal outputted from the LPP detector 510. For example, it is possible to detect, from the LPP data, (i) pre-format address information for indicating an address position on the optical disc 100, and (ii) information for indicating a clock in the recording operation.

The LPP error rate detector 513 is one specific example of the “second measuring device” of the present invention. The LPP error rate detector 513 can detect the incidence ratio of an error of the LPP data detected on the LPP data detector 512 (i.e. an error rate and one specific example of the “reproduction quality of the pre-information” of the present invention). The error rate is referred to as a LPP characteristic after recording (or BERLPPa: Block Error Rate LPP after), for example, and indicates the almost same numerical value as an Aperture Rate (AR) characteristic.

Now, the AR characteristic will be simply explained. The optical pickup 501 has a not-illustrated two-division PD, and can generate push-pull signals from the divisional reading signals. The ratio of the maximum amplitude and the minimum amplitude of a push-pull signal component in the direction of the groove tracks on the optical disc 100 out of push-pull signal components is referred to as the AR characteristic. For example, the maximum amplitude and the minimum amplitude of the reading signal can be recognized by superimposing, on an oscilloscope, the reading signals obtained when the LPP formed on the DVD-R/RW is reproduced, so that the AR characteristic can be detected. On the actual information recording apparatus 1, an operation equal to the measurement of the AR characteristic can be performed by detecting the error rate of the LPP data.

Incidentally, the address information may be recorded with modulating the wobble, instead of the LPP. In this case, the LPP error rate detector 613 (or another component not illustrated) detects a signal quality of the wobble (i.e. C/N characteristic of the wobble or an error rate characteristic of the wobble) instead of the AR characteristic.

The equalizer 520 can perform predetermined filtering (or signal processing) with respect to the RF signal or the like detected by the RF amplifier, and can output the signal after the filtering (e.g. envelop detection or the like) to the RF amplitude measurement circuit 521.

The RF amplitude measurement circuit 521 detects the peak value and the bottom value of the envelop detection of the RF signal, which is the output signal from the RF amplifier 503, in order to determine the optimum recording laser power, under the control of the CPU 550, at the time of reproducing the OPC pattern in the OPC processing. The RF amplitude measurement circuit 521 may include an Analog/Digital (A/D) converter and the like, for example.

The binarization circuit 530 can generate a binary signal from the RF signal or the like detected by the RF amplifier 503. Specifically, the binarization circuit 530 generates a pulse row from the detected RF signal or the like. Then, the binarization circuit 530 can output the binary signal to the NRZI converter 531.

The NRZI converter 531 can perform the NRZI conversion of the binary signal generated by the binarization circuit 530. Then, the NRZI converter 531 can output the converted binary signal to the SYNC detector 532.

The SYNC detector 532 can detect a SYNC signal (or a SYNC frame) corresponding to a synchronization signal, from the NRZI-converted binary signal.

The CPU 550 receives the data from the LPP data detector 512, the RF amplitude measurement circuit 521, or the like, for example, and performs the subsequent control operation, in order to control the operation of the whole information recording apparatus 1. Then, the CPU 550 controls the whole information recording apparatus 1 by outputting a system command to each device which is provided for the information recording apparatus 1, on the basis of the data. Normally, software for operating the CPU 550 is stored in an external memory.

The memory 560 includes a semiconductor memory, such as a Random Access Memory (RAM) and a flash memory, and can temporarily record various data required for the operation of the information recording apparatus 1.

Incidentally, in order to explain the features of the present invention more plainly, the constitutional component required for the embodiment are extracted and shown in the above-described information recording apparatus 1. Thus, it is obvious that the present invention may be provided with a constitutional component other than those described above.

Moreover, the information recording apparatus in the embodiment, which is explained with reference to FIG. 2, can be an embodiment of an information recording/reproducing apparatus. Namely, the information recording apparatus in the embodiment can reproduce the record information via the optical pickup 501 and the RF amplifier 503, and includes the function of the information reproducing apparatus or the information recording/reproducing apparatus.

(Operation Principle)

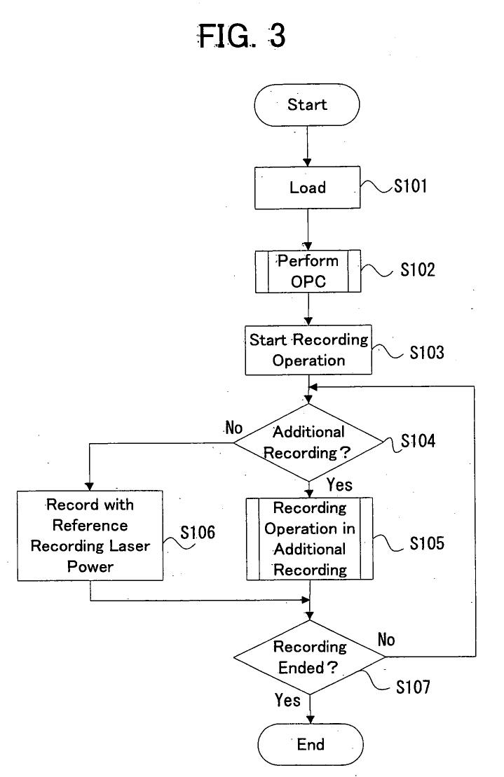

Next, with reference to FIG. 3 to FIG. 15, the operation principle of the information recording apparatus 1 in the embodiment will be explained.

(1) Whole Recording Operation

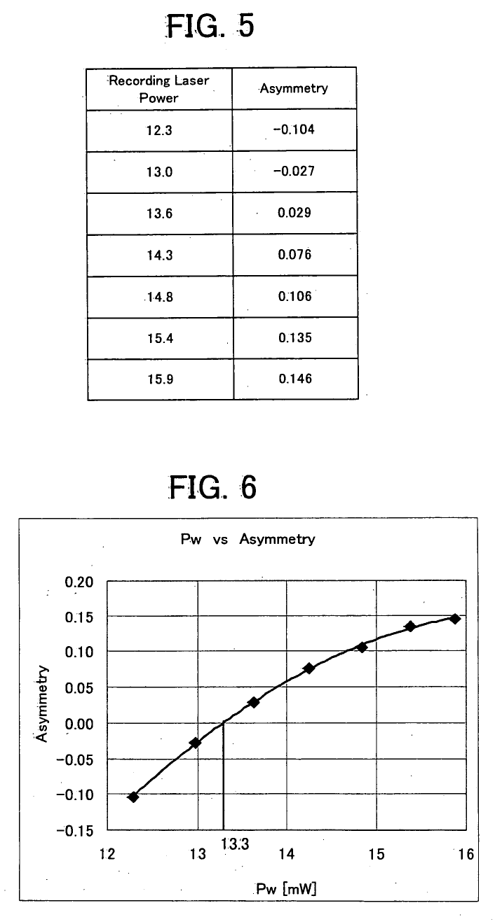

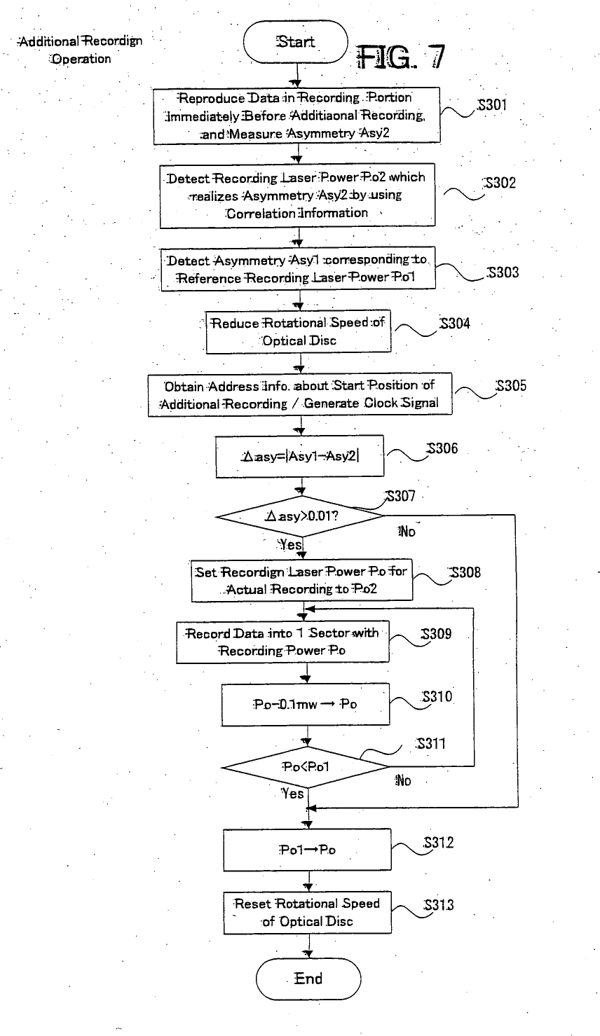

At first, the flow of a whole operation of recording various data of the information recording apparatus in the embodiment, will be explained with reference to FIG. 3 to FIG. 6. FIG. 3 conceptually shows the flow of the whole data recording operation on the information recording apparatus 1 in the embodiment. FIG. 4 conceptually shows the flow of an OPC operation. FIG. 5 shows specific numerical values of a recording laser power and asymmetry, obtained by the OPC operation. FIG. 6 shows correlation information prepared by the OPC operation.

In FIG. 3, at first, the optical disc 100 is loaded (step S101). Then, under the control of the CPU 550, a seek operation is performed by the optical pickup 501, to thereby obtain various data for management, which is required for the recording processing with respect to the optical disc 100. Particularly, by reading the LPP (Land Pre-Pit) in the lead-in area 104, the predetermined pulse strategy (or the pulse strategy as default) is obtained. The data is recorded onto the optical disc 100 via an external input interface or the like, in accordance with an instruction from external input equipment or the like, under the control of the CPU 550, on the basis of the data for management.

After the loading, the OPC operation is performed, under the control of the CPU 550 (step S102). By virtue of the OPC operation, a reference recording laser power Po1, which is a preferable or optimum recording laser power in recording the data, is detected. The OPC operation will be described in detail later (refer to FIG. 4).

Then, the data recording operation is performed (step S103). Specifically, the optical pickup 501 is displaced to a recording area (e.g. the data recording area 106 shown in FIG. 1). The laser light LB is modulated, in accordance with the data to be recorded, with the recording laser power which is obtained by the OPC operation in the step S102 (i.e. the reference recording laser power Po1), under the control of the laser drive circuit 504 or the like. By this, the data is recorded into the data recording area. Namely, the recording pits corresponding to the record data are formed on the tracks.

Then, under the control of the CPU 550, it is judged or determined whether or not the data recording is additional (or postscript) recording (e.g. whether or not the data recording corresponds to the incremental write) (step S104). For example, it may be judged that the data recording is the additional recording if the data is recorded in the recording area adjacent to the recording area where the data is once recorded after a predetermined interval from the time when the data is recorded. Alternatively, it may be judged that the data recording is not the additional recording if the data is continuously recorded (i.e. in the case of the recording operation corresponding to sequential recording).

As a result of this judgment, if it is judged that the data recording is not the additional recording (the step S104: No), the recording operation with the reference recording laser power Po1 is continued (step S106). Obviously, in this case, the recording operation may be performed, while adjusting the reference recording laser power Po1 on the basis of the correlation information as described later.

On the other hand, if it is judged that the data recording is the additional recording (the step S104: Yes), the recording operation in additional recording is performed, subsequently (step S105). The recording operation at the time of additional recording will be described in detail later (refer to FIG. 7 or the like).

Then, under the control of the CPU 550, whether or not to end the recording operation is judged (step S107). Namely, it is judged whether or not all the data to be recorded has been recorded in the recording operation.

As a result of the judgment, if it is judged to end the recording operation (the step S107: Yes), the recording operation is ended. If needed, a finalize operation for ensuring compatibility with an optical disc of read-only (e.g. a DVD-ROM or the like) may be performed. Alternatively, the optical disc 100 may be ejected from the information recording apparatus 1. On the other hand, if it is judged not to end the recording operation (the step S107: No), the recording operation is continued.

Next, the OPC operation in the step S102 will be explained in detail with reference to FIG. 4 to FIG. 6. FIG. 4 conceptually shows the flow of the OPC operation. FIG. 5 shows the relationship between a recording laser power and asymmetry, obtained by the OPC operation. FIG. 6 conceptually shows a specific example of correlation information prepared by the OPC operation.

As shown in FIG. 4, under the control of the CPU 550, the optical pickup 501 is displaced to a power calibration area placed in the lead-in area 104. The recording laser power is changed over, sequentially step-by-step (e.g. a mutually different 16-step recording laser power is changed over), by the control of the OPC circuit 505, the laser drive circuit 504, and the like. By this, the OPC pattern, which is one specific example of the “trial information” of the present invention, is recorded into the power calibration area (step S201). The OPC pattern is generated by the operation of the OPC circuit 505, for example. As one example of the OPC pattern, there is listed a recording pattern in which short pits corresponding to a 3T pulse and long pits corresponding to an 11T pulse (or a 14T pulse) are alternately formed, together with non-recording sections (i.e. space sections) having the same length as their own length.

The laser drive circuit 504 drives the semiconductor laser provided in the optical pickup 501 so as to change over (or change) the recording laser power sequentially step-by-step, in accordance with the OPC pattern outputted from the OPC circuit 505.

Then, the correlation information for indicating the correlation relationship between the recording laser power and the asymmetry is prepared under the control of the CPU 550 (step S202). The CPU 550 is one specific example of the “preparing device” of the present invention. Specifically, after the recording of the OPC pattern into the power calibration area is ended, the OPC pattern recorded in the power calibration area is reproduced under the control of the CPU 550. Then, from the RF signal inputted to the RF amplitude measurement circuit 521, the peak value and the bottom value of the envelop detection of the RF signal are sampled. Then, the OPC pattern is reproduced in accordance with how many times the OPC pattern is recorded in one OPC processing. The asymmetry is measured by using the peak value and the bottom value at each time of the reproduction of each OPC pattern.

By this, it is possible to obtain the recording laser power changed over sequentially step-by-step, and the asymmetry value of the OPC pattern recorded with this recording laser power, as shown in FIG. 5. By plotting the various numerical values shown in FIG. 6 on a graph on which the vertical axis indicates the asymmetry value and the horizontal axis indicates the recording laser power, and connecting them by an approximating curve, a graph shown in FIG. 6 is obtained. Such an approximating curve can be obtained by using a mathematical or statistic method, such as the least-squares method.

Incidentally, in the embodiment, the correlation information is prepared by a curve of second degree, but not limited to this curve. For example, the correlation information may be prepared by an arbitrary function which is shown by a curve of third degree, a curve of fourth degree, and the like. Moreover, it is obvious that even if the graph (or a curve of second degree) shown in FIG. 6 is not actually used, the processing described later may be performed by performing an operation or the like with respect to the correlation information, such as the table shown in FIG. 5 and the correlation equation prepared from the table shown in FIG. 5.

Again in FIG. 4, the recording laser power in which the asymmetry is optimum (i.e. the asymmetry is “0”) is obtained as the reference recording laser power Po1, under the control of the CPU 550 (step S203). For example, if the graph shown in FIG. 6 (the correlation information) is obtained, the value of the recording laser power in which the asymmetry is “0” is obtained as the reference recording laser power Po1. Namely, “13.3 mW” is obtained as the reference recording laser power Po1. This condition that the asymmetry is “optimum (or 0)” corresponds to one specific example of the “desired first target quality” of the present invention.

In terms of the standard of the DVD or the like, the appropriate recording operation or the like can be performed in the asymmetry range of “−0.05” to “0.15”. Thus, it is not always necessary to set the recording laser power in which the asymmetry is “0”, as the reference laser power. For example, it is also possible to set the recording laser power in which the asymmetry is “0.10” or “−0.05”, as the reference laser power.

Then, the correlation information prepared in the step S202 (e.g. the table shown in FIG. 5, the graph or the correlation equation shown in FIG. 6 which is prepared from the table shown in FIG. 5, and the like) is stored into a memory 560, which is one specific example of the “storing device” of the present invention (step S204). At this time, the reference recording laser power Po1 (i.e. a numerical value of “13.3 mW”) is preferably stored into the memory 560 at the same time. At this time, the correlation information and the reference recording laser power Po1 are preferably stored into the memory 560 in association with various identification numbers (e.g. a manufacturer code of the optical disc 100) owned by the optical disc 100. Alternatively, the correlation information and the reference recording laser power Po1 may be recorded into the lead-in area 104 or the like of the optical disc 100, for example.

(2) Recording Operation in Additional Recording

Then, with reference to FIG. 7 to FIG. 10, the recording operation in the additional recording in the step S105 in FIG. 3 will be explained. Here, by focusing on FIG. 7 and referring to the other drawings if needed, the recording operation in the additional recording will be explained. FIG. 7 conceptually shows the flow of the recording operation in the additional recording.

Incidentally, the information recording apparatus 1 is constructed to perform a soft landing operation, in additionally recording the data. Here, the soft landing operation indicates that the recording laser power is changed, smoothly, or gradually by a predetermined adjustment amount or in a predetermined adjustment ratio, in changing the recording laser power. Specifically, it indicates that the recording laser power is changed by “0.1 mW”, for example, to thereby adjust the recording laser power to obtain the desired value in the end.

As shown in FIG. 7, at first, under the control of the CPU 550, the data already recorded in a recording portion (or a recording area) immediately before (or identifiably immediately before) a recording area into which the data is additionally recorded is reproduced, and the asymmetry Asy2 of this data already recorded in a recording portion immediately before the additional recording is measured by the operation of the RF amplitude measurement circuit, which is one specific example of the “first measuring device” of the present invention (step S301). For example, if the data is additionally recorded into an “n” sector, the asymmetry Asy2 of the data recorded in an “n-1” sector (or a sector adjacent to the “n” sector) is measured.

Then, on the basis of the correlation information prepared in the step S202 in FIG. 4, a recording laser power Po2 which realizes the asymmetry Asy2 is detected under the control of the CPU 550, which is one specific example of the “first and second detecting device” of the present invention (step S302). The recording laser power Po2 obtained here corresponds to one specific example of the “link power” of the present invention. Moreover, asymmetry Asy1 corresponding to the reference recording laser power Po1 detected by the OPC operation is detected (step S303).

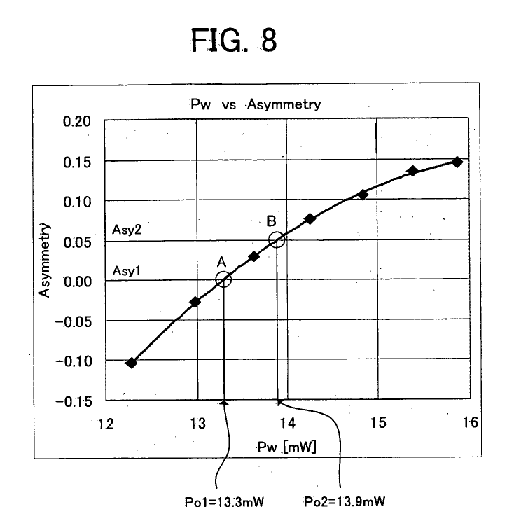

This operation will be explained in detail with reference to FIG. 8. FIG. 8 conceptually shows a state on the correlation information in the recording operation in the additional recording.

As shown in FIG. 8, the recording laser power Po2 which realizes the asymmetry Asy2 is the intersection of the graph shown by the correlation information and the line shown by the asymmetry Asy2. Moreover, the asymmetry Asy1 corresponding to the reference recording laser power Po1 is the intersection of the graph shown by the correlation information and the line shown by the reference recording laser power Po1.

The operation will be specifically explained by using numerical values. It is assumed that the asymmetry Asy2 obtained in the step S301 is “0.05”, and that the reference recording laser power Po1 is “13.3 mW”. In this case, the value of the recording laser power at the intersection of the graph in FIG. 8 and the linear line of the Asy2=“0.05”, is the recording laser power Po2. From this graph, the value of the recording laser Po2 is detected as “13.9 mW”. Moreover, the value of the asymmetry at the intersection of the graph in FIG. 8 and the linear line of the recording laser power Po1=“13.3 mW”, is the value of the asymmetry Asy1. From this graph, the Asy1 is detected as “0”.

Incidentally, the asymmetry Asy1 corresponding to the reference recording laser power Po1 has a value (or a target value) used when the reference recording laser power Po1 is obtained in the step S203 in FIG. 4. Therefore, the asymmetry Asy1 is not necessarily obtained in the step S303 in FIG. 7, and the asymmetry value used in the step S203 in FIG. 4 may be regarded as the asymmetry Asy1.

Again in FIG. 7, the liner velocity of the optical disc 100 is reduced by the operation of the spindle motor circuit 509 (step S304). Here, it is preferable to reduce the liner velocity enough to properly obtain address information in a next step S305. For example, if the normal data recording is performed at recording speeds of 4×, 6×, and the like, the liner velocity may be reduced to the one corresponding to a recording speed of 1×.

Incidentally, in the various operations explained by using FIG. 4 to FIG. 6 described above (e.g. in the OPC operation, in the preparation of the correlation information, and the like), it is preferable not to reduce the liner velocity of the optical disc 100, as described later. For example, if the normal data recording is performed at recording speeds of 4×, 6×, and the like, the various operations such as the OPC operation are preferably performed at the liner velocities corresponding to the recording speeds. If needed, the liner velocity may be reduced.

Then, the address information in the start position of the recording area, in which the additional recording starts, is obtained, and a clock signal in the recording operation is generated (step S305). Specifically, from the LPP data which is obtained by reproducing the LPP formed on the optical disc 100, the address information (e.g. the pre-format address information) is obtained and the clock signal is generated.

Then, under the control of the CPU 550, a difference Δ Asy of the asymmetry obtained in the step S301 and the asymmetry obtained in the step S303 is obtained (step S306). Namely, |Asy1-Asy2| is obtained as the difference Δ Asy. For example, as in the above example, if Asy1=“0.05” and Asy2=0, ΔAsy=“0.05”. Then, under the control of the CPU 550, it is judged whether or not the difference Δ Asy is greater than a numerical value “0.01”, which is one specific example of the “predetermined amount” of the present invention (step S307).

Incidentally, the numerical value which is the judgment reference in the step S307 is not limited to “0.01”. If the soft landing operation is performed more strictly (i.e. the soft landing operation is performed relatively frequently), the numerical value is preferably set to a smaller value. On the other hand, if the soft landing operation is performed less strictly (i.e. the soft landing operation is not performed relatively frequently), the numerical value is preferably set to a larger value. The setting may be performed by the user of the information recording apparatus 1. In this case, the user can use a remote control, an operation button, or the like. Alternatively, the setting may be performed automatically by the CPU 550. Moreover, the process of step S307 is not limited to the judgment by using the numerical value, but the user may input an instruction of whether or not to perform the soft landing operation.

As a result of the judgment, if it is judged that the difference Δ Asy is not greater than 0.01 (the step S307: No), the soft landing operation is not performed. Specifically, an actual recording laser power Po for the actual data recording is set to the reference recording laser power Po1 detected by the OPC operation (step S312), and the subsequent data recording operation (i.e. the additional recording operation) is performed. If the asymmetry Asy1 and the asymmetry Asy2 are not greatly different, an auto slicer descried later can follow the change of the asymmetry, without the soft landing operation. This enables the information reproducing apparatus, such as a player, to reproduce the data properly.

On the other hand, if it is judged that the difference Δ Asy is greater than 0.01 (the step S307: Yes), the actual recording laser power Po for the actual data recording is set to the recording laser power Po2 detected in the step S302 (step S308). Specifically, it is set by the operation of the laser drive circuit 504 such that the output value of a driving pulse for driving the semiconductor laser of the optical pickup 501, which emits the laser light LB, is set to the recording laser power Po2.

Then, with the actual recoding laser power Po set in the step S308, the data is recorded into a recording area corresponding to 1 sector (step S309).

Then, a recording laser power in which 0.1 mW is subtracted from the actual recording laser power Po, is set to the new actual recording laser power Po (step S310) Then, under the control of the CPU 550, it is judged whether or not the new actual recording laser power Po (i.e. the actual recording laser power Po having 0.1 mW smaller power than the previous power) is less than the reference laser power Po1 (step S311).

As a result of the judgment, if it is judged that the actual recording laser power Po is not less than the reference recording laser power Po1 (the step S311: No), the data is recorded again into a recording area corresponding to 1 sector, with the actual recording laser power Po1 having 0.1 mW smaller power (the step S309), and the subsequent operations are repeated. At this time, the recording area corresponding to 1 sector in which the data is recorded is preferably a recording area adjacent to the previous recording area in which the data is previously recorded. On the other hand, if it is judged that the actual recording laser power Po is less than the reference recording laser power Po1 (the step S311: Yes), the Po1 is set to the new actual recording laser power Po (step S312), and further, the liner velocity of the optical disc 100 is reset (step S313). Then, the recording operation shown in FIG. 3 is continued.

Incidentally, in FIG. 7, it is assumed that the recording laser power Po2 is greater than the reference recording laser power Po1. Therefore, if the recording laser power Po2 is less than the reference recording laser power Po1, it is necessary to regard a recording laser power in which 0.1 mW is added, as the new actual recording laser power Po in the step S310, and record the data sequentially. Then, in the judgment in the step S311, it is necessary to judge whether or not the actual recording laser power Po is greater than the reference recording laser power Po1.

Moreover, the numerical value of “0.1 mW”, which is added or subtracted, as occasion demands, in the step S310 (i.e. one specific example of the “predetermined adjustment amount” or the “predetermined adjustment ratio” of the present invention), may be changed if desired. For example, if the change of the recording laser power is made milder, it is preferable to reduce the numerical value. On the other hand, if the change of the recording laser power is made abrupt, yet if it is desired to reduce the number of changing steps, it is preferable to increase the numerical value. Moreover, the numerical value of “1 sector”, which is the areal size of the area in which the data is recorded in the step S309, may be changed if desired. For example, it may be constructed such that the data is recorded by a unit of several sectors, a unit of 1 ECC block, a unit of several ECC blocks, or a unit of recording area associated with a predetermined size other than the above-listed examples. Alternatively, the areal size of the area in which the data is recorded in step S309 or the numerical value of the recording laser power which is added or subtracted in the step S310 may be set in accordance with a time required for the change of the recording laser power. For example, it may be constructed such that the recording laser power may be changed from the recording laser power Po2 to the reference recording laser power Po1 in about one second. Such change may be performed automatically by the operation of the CPU 550, for example, or performed on the basis of an instruction from the user by using a remote control, an operational button, and the like.

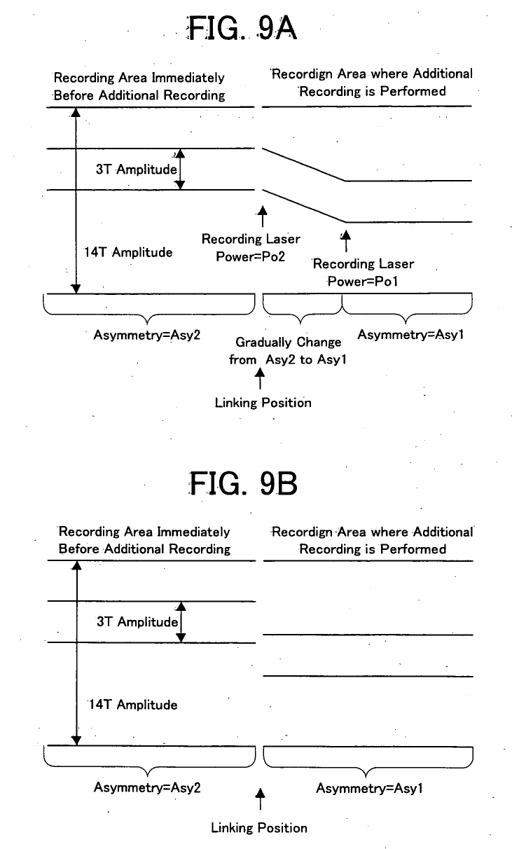

With reference to FIG. 9A and FIG. 9B, an explanation is given about the asymmetry of the data which is recorded, if the data is recorded by performing the soft landing operation in the recording area in which the data is additionally recorded. FIG. 9A conceptually show the state of the asymmetry before and after a change of a linear velocity, and FIG. 9B conceptually shows the state of the asymmetry in a comparison example.

As shown in FIG. 9A, according to the information recording apparatus of the present invention, for example, the change of the asymmetry of a 3T amplitude pattern becomes milder near the border of (i) the recording area immediately before the data is additionally recorded and (ii) the recording area in which the data is additionally recoded. Namely, the asymmetry does not change suddenly in a linking position which is one boundary line of the data recording and which corresponds to the recording area from which the additional recording of the data is started. The asymmetry changes relatively mildly. Specifically, the asymmetry changes gradually from Asy2 to Asy1, and the continuity of the asymmetry can be maintained. Therefore, even if the auto slicer of the information reproducing apparatus has bad responsiveness, or even if a data structure in which a lossless link or the like is adopted, the auto slicer can follow the change of the asymmetry, so that it is possible to properly reproduce the data.

Incidentally, the auto slicer mainly traces the data recorded on the optical disc 100 (specifically recording pits and the like), and binalizes a signal reproduced from the recording pits.

If the soft landing operation as shown in the embodiment is not performed, the asymmetry changes suddenly or abruptly in the linking position which corresponds to the recording area from which the additional recording of the data is started. Namely, the asymmetry changes suddenly or abruptly from Asy2 to Asy1, so that it is difficult or almost impossible to maintain the continuity of the asymmetry. Thus, if the auto slicer of the information reproducing apparatus has bad responsiveness or if a distance between one data and other data recorded subsequent to the one data is relatively narrow as in the lossless link, the auto slicer cannot follow the change of the asymmetry, so that it is hardly possible to properly reproduce the data (e.g. the occurrence of a reading error or the like), which is disadvantageous.

Thus, by performing the soft landing operation, it is possible to efficiently prevent such a disadvantage, and it is possible to record the data preferably so that the information reproducing apparatus can reproduce the data properly, which is greatly advantageous.

Moreover, the adjustment operation of adjusting the recording laser power, which includes the soft landing operation, is performed on the basis of the correlation information obtained by the OPC operation. Namely, it is possible to properly adjust the recording laser power to change the asymmetry, more smoothly, by using the asymmetry of the actually recorded data and the correlation information obtained by the OPC processing. Incidentally, in the conventional OPC processing, if the value of the reference recording laser power is obtained, various data obtained in the processing (i.e. the correlation information and the like, for example) is disused. In the embodiment, however, by efficiently using the various data (particularly, the correlation information), it is possible to obtain the more preferable recording laser power corresponding to the recording characteristics of the optical disc 100 or the like, which is greatly advantageous.

In addition, in the case of the additional recording of the data on the information recording apparatus 1 in the embodiment, the liner velocity of the optical disc 100 is reduced before the various address information is obtained and the data is additionally recorded. By this, it is possible to realize the more appropriate or highly reliable recording operation. In general, in order to properly read the data (e.g. the address information and the clock signal indicated by the LPP data, or the like) from the optical disc 100 which rotates at a relatively high liner velocity, it is necessary to make the various processing circuits such as the RF amplifier 503 or the like compatible with the high-velocity recording or high-velocity reproduction. Therefore, depending on the properties of the information recording apparatus, there may be some cases that it is difficult or almost impossible to read the data from the optical disc 100 which rotates at a relatively high liner velocity, or that it is difficult or almost impossible to record the data onto the optical disc 100. Particularly, such a state is notable at the time of the additional recording operation in which the data is not continuously recorded. In the embodiment, however, the liner velocity of the optical disc 100 is reduced in the additional recording, so that it is possible to prevent the occurrence of the above-described problems. Namely, it is possible to properly obtain the address information or the like, and to maintain the continuity of the asymmetry more properly because the additional recording of the data can be stably performed. Moreover, after the recording operation is stabilized (e.g. after the asymmetry changes properly and continuously), even if the liner velocity is increased again, it is possible to efficiently prevent the various problems such as the discontinuity of the asymmetry (or the discontinuity of the data which is recorded), which is greatly advantageous.

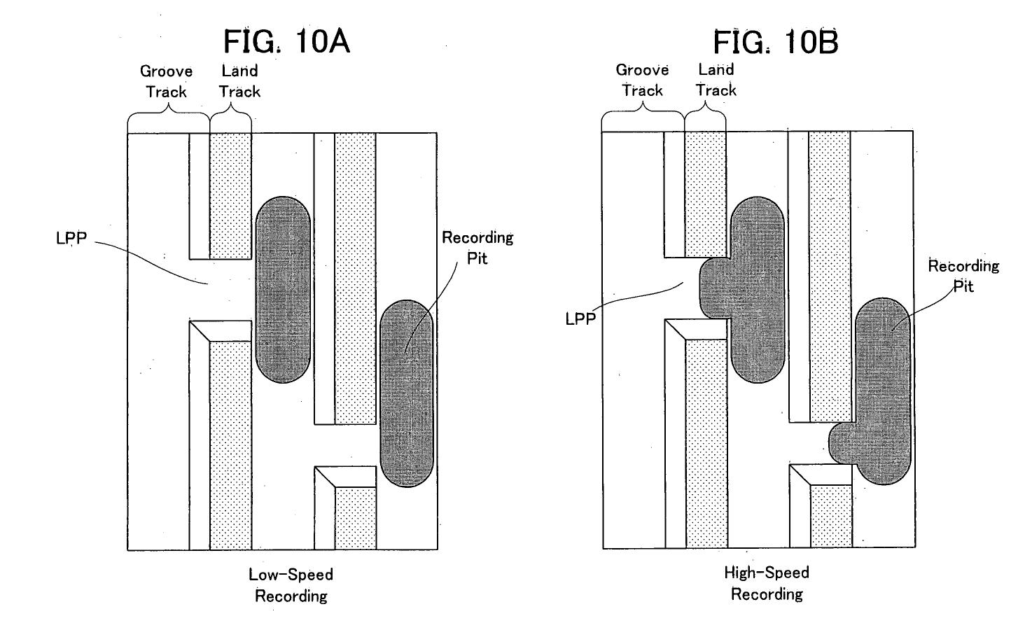

Moreover, by additionally recording the data after the reduction of the liner velocity of the optical disc 100, it is possible to make the preferable shapes of the recording pits or recording marks, actually formed on the recording surface of the optical disc 100. The shapes of the recording pits will be explained with reference FIG. 10 A and FIG. 10B. FIG. 10A and FIG. 10B conceptually explain the shapes of the recording pits formed in low-velocity recording and high-velocity recording, respectively.

As shown in FIG. 10A, in the low-velocity recording (e.g. in the recording at recording speeds of relatively 1× and 2×), because the liner velocity of the optical disc 100 is relatively slow, a time required for the irradiation with the laser light LB is longer than that in the high-velocity recording (e.g. in the recording at a recording speed of relatively 4× or more). Therefore, the recording pits are formed in an appropriate pit shape.

On the other hand, as shown in FIG. 10B, in the high-velocity recording, because the liner velocity of the optical disc 100 is relatively fast, a time required for the irradiation with the laser light LB is shorter that in the low-velocity recording. In addition, as the liner velocity of the optical disc 100 increases, the power of the laser light LB required for the recording operation also increases. Therefore, due to the short-time irradiation with the laser light LB with a high laser power, the recording pits are formed not only on groove tracks GT, which are recording tracks formed on the optical disc 100, but also on the LPP. This greatly deteriorates the AR characteristic (or BERLPPa) which is a reading characteristic. This type of situation is not preferable at all, from the viewpoint of the acquisition of the address information and the generation of the clock signal.

However, according to the information recording apparatus in the embodiment, the liner velocity of the optical disc is reduced (i.e. the recording speed is reduced) in the additional recording of the data, so that it is possible to properly detect the LPP data without the deterioration of the AR characteristic, which is the reading characteristic of the LPP data. As a result, it is possible to properly obtain the address information and generate the clock signal. Thus, it is possible to realize the proper data recording operation.

In view of such problems as the deterioration of the AR characteristic, it is preferable to reduce the liner velocity of the optical disc 100 to the one at which the AR characteristic can realize a good value (e.g. 15% or more) in the step S304 in FIG. 7. Namely, the condition that the AR characteristic is “good (e.g. 15% or more)” corresponds to one specific example of the “desired second target quality” of the present invention. The liner velocity may be determined on the basis of the actually measured AR characteristic (or the BERLPPa). Alternatively, the value of the liner velocity at which the AR characteristic is expected to be good may be determined as default.

Moreover, in resetting the liner velocity of the optical disc 100 in the step S313 in FIG. 7, the liner velocity is preferably changed (i.e. incremented) step-by-step by a predetermined amount, or continuously in a predetermined ratio. By avoiding the abrupt change of the liner velocity, it is possible to maintain the continuity of the asymmetry, more preferably.

Incidentally, by setting the shape of the driving pulse, which is inputted to the semiconductor laser in the optical pickup 501 for the purpose of the irradiation with the laser light LB, to a predetermined shape (e.g. a shape in which there are a top pulse and a middle pulse having different peak values), it is possible to realize the appropriate pit shape, as shown in FIG. 9A, even in the high-velocity recording.

Moreover, even during the normal recording of the data, the recording laser power may be adjusted if needed, as in the additional recording of the data. For example, the recording laser power may be adjusted during the normal recording operation, if needed, such that the desired asymmetry value is realized by measuring the asymmetry of the recording area in which the data is recorded and by comparing the measured asymmetry and the originally desired asymmetry value. At this time, the recording laser power may be adjusted while the soft landing operation is performed as described above. Alternatively, the recording laser power may be adjusted without performing the soft landing operation. By this, it is possible to continue the more appropriate data recording, and improve the reproduction quality of the recorded data.

Moreover, in the embodiment, the value of the asymmetry is used as one specific example of the “reproduction quality” of the present invention. The present invention, however, is not limited to this, and the recording laser power may be adjusted on the basis of various reproduction qualities, such as a jitter value, a reproduction error rate, the degree of modulation, the reflectivity of the laser light, and the AR characteristic. For example, the value of the recording laser power at which the jitter value is the smallest, may be determined to be the value of the reference recording laser power. Alternatively, the value of the recording laser power at which the reproduction error rate is the smallest, may be determined to be the value of the reference recording laser power. The value of the recording laser power may be obtained in consideration of the plurality of the reproduction qualities, as occasion demands. Alternatively, the value of the recording laser power may be obtained by setting in advance a high-priority out of these reproduction qualities.

Incidentally, in the embodiment as described above, the changes of the reproduction signal quality (i.e. the change of the asymmetry) become milder by changing (or optimizing) the recording laser power. However, the changes of the reproduction signal quality may become milder by changing at least one of the recording strategy, the tilt condition in recording, defocus condition and de-track condition. For example, in changing the recording strategy, narrowing the width of the pulse stepwise makes the same effect as changing the recording laser power. In changing the tilt condition, a diameter of a spot in recording operation may be changed by tilting the pickup 501 with respect to the optical disc 100. It makes the same effect as changing the recording laser power. In changing the defocus condition or the de-track condition, same argument is applied.

(3) First Modified Operation Example

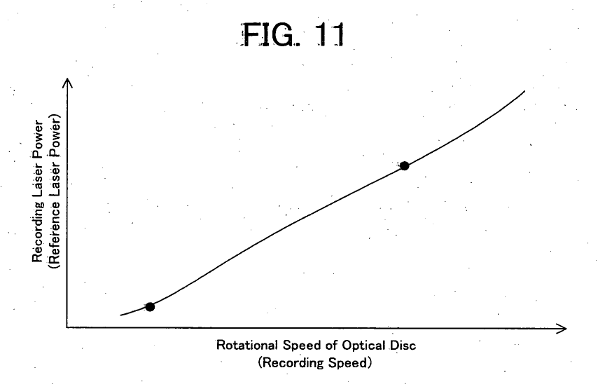

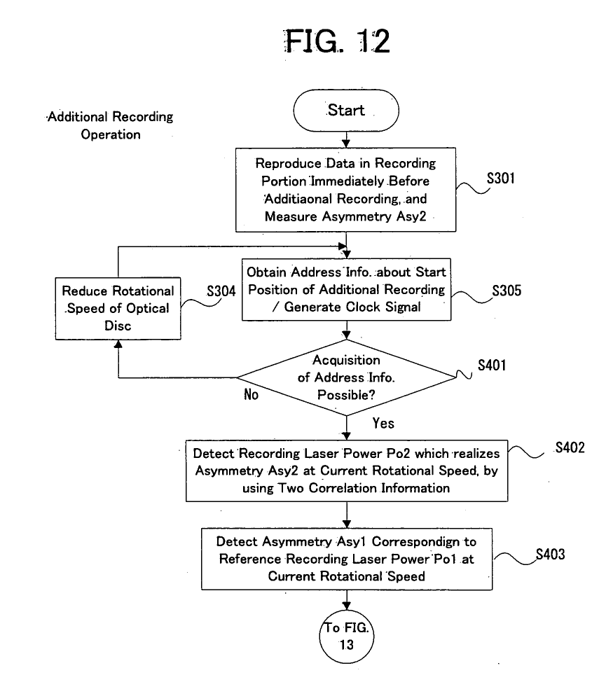

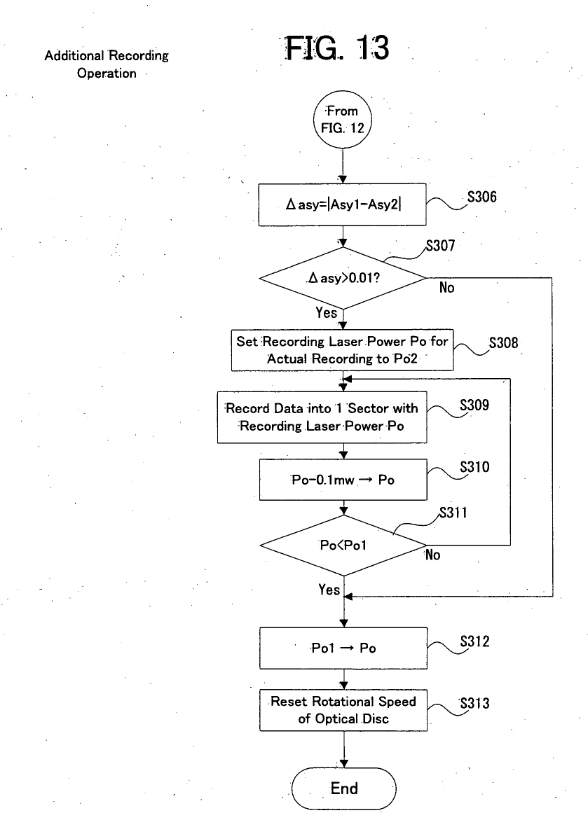

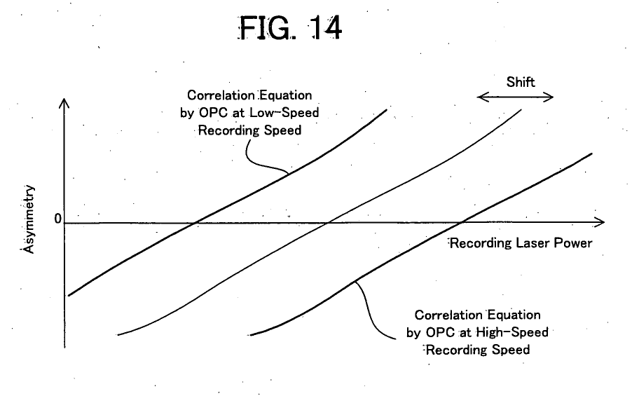

Next, with reference to FIG. 11 to FIG. 14, the first modified operation example of the recording operation in the additional recording in the step S105 in FIG. 3 will be explained. FIG. 11 shows a correlation relationship between the liner velocity (recording speed) of the optical disc 100 and the recording laser power. FIG. 12 and FIG. 13 conceptually show operational flows in the first modified operation. FIG. 14 shows a correlation relationship between the recording laser power and the asymmetry, if the liner velocity of the optical disc 100 is changed.

Incidentally, the first modified operation example is an operational aspect in which the data is additionally recorded while the liner velocity of the optical disc 100 is changed, as occasion demands, and the recording laser power is modified in accordance with the change of the liner velocity.

In the first modified operation example, the correlation information for indicating the correlation relationship between the liner velocity of the optical disc and the recording laser power (particularly, the reference recording laser power) as shown in FIG. 11 is prepared in the OPC operation in FIG. 4. Specifically, while the liner velocity of the optical disc 100 is changed, the OPC operation is performed by changing the recording laser power at each of the changed liner velocitys. Then, on the basis of the reference recording laser power according to the liner velocity of the optical disc 100 detected by the OPC operation, the correlation information shown in FIG. 11 is prepared. For example, the OPC operation is performed at a relatively high liner velocity (or at a high recording speed) on the outer circumferential side (e.g. a power calibration area placed in the lead-out area 108), while the OPC is performed at a relatively low liner velocity (or at a low recording speed) on the inner circumferential side (e.g. a power calibration area placed in the lead-in area 104). By this, the results of the OPC operation corresponding to the two liner velocitys (e.g. the correlation relationship between the recording laser power and the asymmetry, the reference recording laser power, or the like) are obtained. On the basis of the two results, the correlation information as shown in FIG. 11 can be prepared by using a mathematical or statistic method, such as the least-squares method. If the additional recording operation described later is performed, it is performed while the recording laser power is adjusted, as occasion demands, on the basis of both (i) the correlation information for indicating the correlation relationship between the liner velocity and the recording laser power and (ii) the correlation information for indicating the correlation relationship between the asymmetry and the recording laser power.

Then, if the data is actually additionally recorded, the data recorded in a recording portion immediately before (or identifiably immediately before) the additional recording is reproduced, and the asymmetry Asy2 of the data is detected, as shown in FIG. 12 (the step S301).

Then, the address information about the start position of the recording area in which the data is additionally recorded is obtained, and the clock signal in the recording operation is generated (the step S305). Then, under the control of the CPU 550, it is judged whether or not the acquisition of the address information and the like can be performed properly in the step S305 (step S401). Specifically, it is judged whether or not the LPP can be reproduced properly, or whether or not the address information can be obtained properly, or the clock signal can be generated properly, from the LPP data detected from the reproduced LPP.

As a result of the judgment, if it is judged that the acquisition of the address information and the like cannot be performed properly (the step S401: No), the liner velocity of the optical disc 100 is reduced (the step S304). Here, the liner velocity may be reduced only by a predetermined amount or ratio. Alternatively, the liner velocity may be reduced only by a predetermined amount or ratio which is specified by the user of the information recording apparatus 1 or the like. Then, the address information about the start position of the recording area in which the data is additionally recorded is obtained again, and the clock signal in the recording operation is generated again. Namely, the liner velocity of the optical disc 100 is reduced, sequentially step-by-step or continuously, to a degree enough to obtain the address information about the start position of the recording area in which the data is additionally recorded and to generate the clock signal in the recording operation.

On the other hand, if it is judged that the acquisition of the address and the like can be performed (the step S401: Yes), then, the recording laser power Po2 which realizes the asymmetry Asy2 at the current liner velocity of the optical disc 100 (i.e. at the liner velocity after the reduction) is detected, by using both (i) the correlation information for indicating the correlation relationship between the recording speed and the recording laser power and (ii) the correlation information for indicating the correlation relationship between the recording laser power and the asymmetry (step S402). Moreover, the asymmetry Asy1 corresponding to the reference recording laser power Po1 at the current liner velocity of the optical disc 100 is detected (step S403).

Specifically, the detection operation of detecting the recording laser power Po2 and the asymmetry Asy1 will be explained with reference to FIG. 14.

As shown in FIG. 14, a graph which indicates the correlation information prepared by the OPC operation shifts to the right or left, depending on the liner velocity of the optical disc. More specifically, as seen from the graph shown in FIG. 11, as the liner velocity of the optical disc increases, the reference recording laser power increases. Namely, it is apparent that in order to realize the same asymmetry, as the liner velocity of the optical disc increases, the larger recording laser power is needed. Therefore, as shown in FIG. 14, the graph shifts to the right at a relatively high liner velocity, and the graph shifts to the left at a relatively low liner velocity. In the first modified operation example, both the graph which indicates the result of the OPC at the high liner velocity and the graph which indicates the result of the OPC at the low liner velocity are prepared, for example. Thus, it is possible to obtain the correlation information corresponding to the current liner velocity on the basis of these graphs and the current liner velocity. Then, from the correlation information, the recording laser power Po2 and the asymmetry Asy1 are detected.

Again in FIG. 12, the additional recording operation of the data is performed while the recording laser power is adjusted as occasion demands (the step S306 to the step S312). Then, if the continuity of the asymmetry can be maintained in the recording portion in which the data is additionally recorded, the liner velocity of the optical disc 100 is reset again (step S313), and the subsequent recording operation is performed.

As described above, by reducing the liner velocity of the optical disc 100 step-by-step, to a degree enough to obtain the address information and generate the clock signal, it is unnecessary to reduce the liner velocity of the optical disc 100 needlessly. Therefore, it is possible to receive the above-described various benefits, and in some cases, it is possible to properly perform the additional recording operation of the data without reducing the recording speed or reading speed of the data needlessly.

Incidentally, in the first modified operation example, if the data is actually additionally recorded (the step S306 to the step S312 in FIG. 13), the liner velocity of the optical disc 100 is constant. However, even if the data is actually additionally recorded, the liner velocity of the optical disc 100 may be changed (specifically, increased) gradually stepwise, or continuously. Even in this case, it is preferable to adjust the recording laser power, as occasion demands, so as to maintain the continuity of the asymmetry, on the basis of both (i) the correlation information for indicating the correlation relationship between the liner velocity of the optical disc 100 and the recording laser power and (ii) the correlation information for indicating the correlation relationship between the recording laser power and the asymmetry.

Moreover, even in resetting the liner velocity of the optical disc 100 in the step S313 in FIG. 13, it is preferable to adjust the recording laser power (and more specifically, the reference recording laser power), as occasion demands, so as to maintain the continuity of the asymmetry, on the basis of both (i) the correlation information for indicating the correlation relationship between the liner velocity and the recording laser power and (ii) the correlation information for indicating the correlation relationship between the recording laser power and the asymmetry.

(4) Second Modified Operation Example

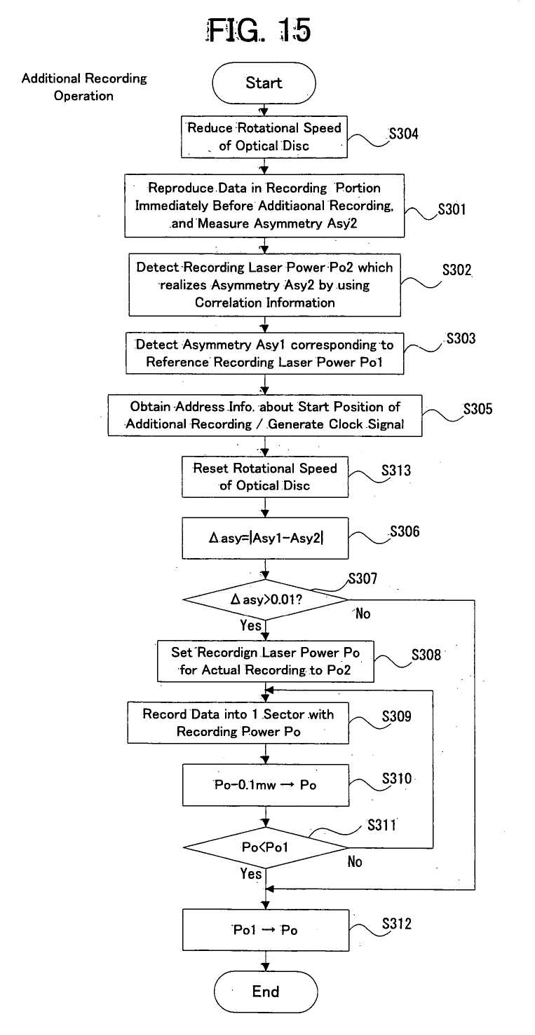

Next, with reference to FIG. 15, a second modified operation example associated with the recording operation at the time of additional recording in the step S105 in FIG. 3 will be explained. FIG. 15 conceptually shows an operational flow in the second modified operation.

Incidentally, the second modified operation example is an operational aspect in which the liner velocity of the optical disc 100 is reduced only when the address information is obtained and the clock signal is generated, and the liner velocity of the optical disc 100 is reset when the data is actually additionally recorded.

As shown in FIG. 15, at first, the liner velocity of the optical disc 100 is reduced (the step S304). Then, as in the above-described operation example, the asymmetry Asy2 is measured (the step S301), the recording laser power Po2 is detected (the step S302), and the asymmetry Asy1 is detected (the step S303).

Then, the address information about the start position of the additional recording is obtained, and the clock signal is generated (the step S305) If the acquisition of the address information and the like can be performed properly, the liner velocity of the optical disc 100 is reset, and the subsequent recording operation is performed.

In the second modified operation example, the liner velocity of the optical disc 100 is reduced only when the asymmetry is measured and the address information is obtained. Therefore, it is possible to properly measure the asymmetry and obtain the address information, both of which specifically become problems in the case of the high liner velocity of the optical disc 100. On the other hand, if the data is actually additionally recorded, the liner velocity of the optical disc 100 is reset. Therefore, it is possible to perform the high-velocity recording of the data, and realize the efficient recording operation.

Incidentally, in the flowchart shown in FIG. 15, both the measurement of the asymmetry and the acquisition of the address information are performed by reducing the liner velocity of the optical disc 100. However, the liner velocity of the optical disc 100 may be reduced only at the time of the acquisition of the address information, or only at the time of the measurement of the asymmetry.

Moreover, in the above-described embodiment, the optical disc 100 is explained as one example of the information recording medium, and the recorder associated with the optical disc 100 is explained as one example of the information recording apparatus. The present invention, however, is not limited to the optical disc and the recorder thereof, and can be applied to other various high-density-recording or high-transmission-rate information recording media, and the recorders thereof.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-076026 filed on Mar. 17, 2004 including the specification, claims, drawings and summary is incorporated herein by reference in its entirety.

1. An information recording apparatus comprising:
an information recording device for recording record information onto an information recording medium by irradiating the information recording medium with laser light having a variable recording power) and
a first measuring device for measuring, if the record information is additionally recorded, reproduction quality of the record information recorded in a recording area adjacent to the record information to be additionally recorded; wherein
said information recording device additionally records the record information into a link area, which is next to the recording area adjacent to the record information to be additionally recorded, with a record parameter on which the reproduction quality measured by said first measuring device is obtained, if the record information is additionally recorded into the link area.

2. The information recording apparatus according to claim 1, wherein the record parameter is defined by one of or at least two of the recording power, a recording strategy, a tilt condition in recording, defocus condition and de-track condition, the record parameter is optimized so that the reproduction quality measured by said first measuring device is obtained on the link area, if the record information is additionally recorded into the link area.

3. The information recording apparatus according to claim 1 further comprising:
a first detecting device for detecting a link power, which is the recording power from which the reproduction quality measured by said first measuring device is obtained, on the basis of correlation information for indicating a correlation between the recording power and the reproduction quality associated with the record information; wherein
said information recording device additionally records the record information into the link area with the link power detected by said first detecting device.

4. The information recording apparatus according to claim 1 further comprising:
a second detecting device for detecting a link strategy, which is a recording strategy from which the reproduction quality measured by said first measuring device is obtained, on the basis of correlation information for indicating a correlation between the recording strategy and the reproduction quality associated with the record information; wherein
said information recording device additionally records the record information into the link area with the link strategy detected by said second detecting device.

5. The information recording apparatus according to claim 1 further comprising:
a rotation controlling device for controlling a liner velocity of the information recording medium such that a first velocity, which is the liner velocity in the additional recording of the record information, is more suitable to the recording of the record information compared to a second velocity, which is the liner velocity in normal recording other than the additional recording of the record information.

6. The information recording apparatus according to claim 3 further comprising;
a first adjusting device for adjusting the recording power stepwise by a predetermined adjustment amount, or continuously in a predetermined ratio, such that the recording power changes from the link power to a reference power, which is the recording power from which desired first target quality is obtained as the reproduction quality, if the record information is additionally recorded.

7. The information recording apparatus according to claim 6, wherein said first adjusting device adjusts the recording power to the reference power directly, if a difference between the link power and the reference power is less than or equal to a predetermined amount.

8. The information recording apparatus according to claim 4 further comprising:
a second adjusting device for adjusting the recording strategy stepwise by a predetermined adjustment amount, or continuously in a predetermined ratio, such that the recording strategy changes from the link strategy to a reference strategy, which is the recording strategy from which desired first target quality is obtained as the reproduction quality, if the record information is additionally recorded.

9. The information recording apparatus according to claim 8, wherein said second adjusting device adjusts the recording strategy to the reference strategy directly, if a difference between the link strategy and the reference strategy is less than or equal to a predetermined amount.

10. The information recording apparatus according to claim 5, wherein
pre-information including address information is recorded on the information recording medium,
said information recording apparatus further comprises a second measuring device for measuring the reproduction quality of the pre-information, and
the first velocity is the liner velocity at which desired second target quality is obtained as the reproduction quality of the pre-information measured by said second measuring device.

11. An information recording apparatus comprising:
a rotating device for rotating an information recording medium;
a rotation controlling device for controlling said rotating device to thereby change a liner velocity of the information recording medium;
an information recording device for recording record information onto the information recording medium by irradiating the information recording medium with laser light;
a power controlling device for controlling a recording power of the laser light; and
a first measuring device for measuring reproduction quality of the record information recorded on the information recording medium, wherein
the liner velocity is changed by said rotation controlling device, and the recording power is controlled by said power controlling device so that the record information is additionally recorded with the recording power according to the reproduction quality measured by said first measuring device.

12. The information recording apparatus according to claim 11, wherein said power controlling device controls the recording power to stepwise or continuously change to a reference power, which is the recording power from which desired first target quality is obtained as the reproduction quality, while the record information is additionally recorded.

13. The information recording apparatus according to claim 12, wherein
said first measuring device measures the reproduction quality of the record information recorded on the information recording medium, and
said power controlling device controls the recording power to stepwise or continuously change from a link power, which is the recording power from which the reproduction quality measured by said first measuring device is obtained, to the reference power.

14. The information recording apparatus according to claim 11, wherein
pre-information including address information is recorded on the information recording medium,
said information recording apparatus further comprises a second measuring device for measuring the reproduction quality of the pre-information, and
said rotation controlling device changes the liner velocity so that desired second target quality is obtained as the reproduction quality of the pre-information.

15. The information recording apparatus according to claim 10, wherein the reproduction quality of the pre-information is at least one of an Aperture Rate (AR) characteristic and a LPP characteristic after recording.

16. The information recording apparatus according to claim 14, wherein the reproduction quality of the pre-information is at least one of an AR characteristic and a LPP characteristic after recording.

17. The information recording apparatus according to claim 10, wherein the reproduction quality of the pre-information is at least one of a C/N characteristic of a wobble and error rate characteristic of the wobble.

18. The information recording apparatus according to claim 14, wherein the reproduction quality of the pre-information is at least one of a C/N characteristic of a wobble and error rate characteristic of the wobble.

19. The information recording apparatus according to claim 11, wherein said power controlling device controls the recording power to additionally record the record information with the recording power according to the reproduction quality measured by said first measuring device, on the basis of correlation information for indicating a correlation relationship between the recording power and the reproduction quality.

20. The information recording apparatus according to claim 3, further comprising:
a trial recording device for recording trial information into a predetermined recording area of the information recording medium while changing the recording power; and
a preparing device for preparing the correlation information by reproducing the trial information.

21. The information recording apparatus according to claim 19, further comprising:
a trial recording device for recording trial information into a predetermined recording area of the information recording medium while changing the recording power; and
a preparing device for preparing the correlation information by reproducing the trial information.

22. The information recording apparatus according to claim 20, wherein said information recording device records the correlation information onto the information recording medium.

23. The information recording apparatus according to claim 21, wherein said information recording device records the correlation information onto the information recording medium.

24. The information recording apparatus according to claim 20, further comprising a storing device for storing the correlation information therein.

25. The information recording apparatus according to claim 21, further comprising a storing device for storing the correlation information therein.

26. The information recording apparatus according to claim 1, wherein the reproduction quality of the record information includes at least one of an asymmetry value, a jitter value, and a reproduction error rate.

27. The information recording apparatus according to claim 11, wherein the reproduction quality of the record information includes at least one of an asymmetry value, a jitter value, and a reproduction error rate.

28. An information recording method on an information recording apparatus comprising an information recording device for recording record information onto an information recording medium by irradiating the information recording medium with laser light having a variable recording power,
said information recording method comprising:
a first measuring process of measuring, if the record information is additionally recorded, reproduction quality of the record information recorded in a recording area adjacent to the record information to be additionally recorded; and
a recording process of recording the record information, wherein
the record information is additionally recorded into a link area, which is next to the recording area adjacent to the record information to be additionally recorded, with a record parameter on which the reproduction quality measured in said first measuring process is obtained, if the record information is additionally recorded into the link area.

29. An information recording method on an information recording apparatus comprising: a rotating device for rotating an information recording medium; and an information recording device for recording record information onto the information recording medium by irradiating the information recording medium with laser light,
said information recording method comprising:
a rotation controlling process of controlling said rotating device to thereby change a liner velocity of the information recording medium;
a power controlling process of controlling a recording power of the laser light; and
a first measuring process of measuring reproduction quality of the record information recorded on the information recording medium, wherein
the liner velocity is changed in said rotation controlling process, and the recording power is controlled in said power controlling process so that the record information additionally recorded with the recording power according to the reproduction quality measured by said first measuring device.

30. A computer program product in a computer-readable medium for tangibly embodying a program of instructions executable by a computer to make the computer function as an information recording apparatus,
said information recording apparatus comprising:
an information recording device for recording record information onto an information recording medium by irradiating the information recording medium with laser light having a variable recording power; and
a first measuring device for measuring, if the record information is additionally recorded, reproduction quality of the record information recorded in a recording area adjacent to the record information to be additionally recorded; wherein
said information recording device additionally records the record information into a link area, which is next to the recording area adjacent to the record information to be additionally recorded, with a record parameter on which the reproduction quality measured by said first measuring device is obtained, if the record information is additionally recorded into the link area.

31. A computer program product in a computer-readable medium for tangibly embodying a program of instructions executable by a computer to make the computer function as an information recording apparatus,
said information recording apparatus comprising:
a rotating device for rotating an information recording medium;
a rotation controlling device for controlling said rotating device to thereby change a liner velocity of the information recording medium;
an information recording device for recording record information onto the information recording medium by irradiating the information recording medium with laser light;
a power controlling device for controlling a recording power of the laser light; and
a first measuring device for measuring reproduction quality of the record information recorded on the information recording medium, wherein
the liner velocity is changed by said rotation controlling device, and the recording power is controlled by said power controlling device so that the record information is additionally recorded with the recording power according to the reproduction quality measured by said first measuring device.
